(19) United States
(12) Patent Application Publication
(10) Pub. No.: US 2003/0125975 A1
(43) Pub. Date: Jul. 3, 2003

(54) Method for generating licenses

(75) Inventors: Mirko Danz, Feucht (DE); Juergen Olomski, Herzogenaurach (DE); Jurgen-Andreas Reimann, Herzogenaurach (DE)

Correspondence Address: Henry M. Feiereisen, Suite 3220, 350 Fifth Avenue, New York, NY, 10118, US

(73) Assignee: Siemens Aktiengesellschaft, Munchen (DE)

(21) Appl. No.: 10/292,815

(22) Filed: Nov. 12, 2002

(30) Foreign Application Priority Data
Nov. 14, 2001 (DE) 101 55 755.8

(51) Int. Cl. G06F 17/60

(52) U.S. Cl. 705/1; 705/59

(57) ABSTRACT

A method is disclosed for licensing software components and providing access authorization to software modules for industrial controllers, control systems and/or computer systems. A user is offered a license to software components and/or modules, wherein at least one software module with application software is created by the user and at least one license information is assigned to the created software module.

### CROSS-REFERENCES TO RELATED APPLICATIONS

This application claims the priority of German Patent Application, Serial No. 101 55 755.8, filed Nov. 14, 2001, pursuant to 35 U.S.C. 119(a)-(d), the disclosure of which is incorporated herein by reference.

### BACKGROUND OF THE INVENTION

The present invention relates to a method for generating a license and/or an access authorization to one or more software modules for an industrial control system, computer system and/or computer network.

It is customary to link licensing and access authorization of software modules to license certificates. A manufacturer develops, licenses and distributes software. For example, the manufacturer of an industrial control system offers software modules for control applications that require a license. For example, a manufacturer of machine tools, having the function of a user, acquires the industrial control system with corresponding software. The produced software program is then distributed to customers that use the machine tool. However, the user, i.e., the manufacturer of the machine tool, disadvantageously does not protect the engineered software with an automatic license mechanism.

Software components, as well as entire libraries of software components, created by the user and having been sold once, can be copied by the customer, i.e., the end-user, as many times as desired and can hence be used on any device, such as other industrial controls and/or computer systems, even if the license agreement provides for different licensing terms. The outside of the device does not readily indicate if the user software component is used according to the terms of the license agreement or not. Accordingly, the user is also not explicitly advised if a term of the license is violated. The user, which can also be referred to as OEM, also loses income if the software components are not legally used. It is also not possible for an OEM to introduce its own license mechanisms into the system.

It would therefore be desirable and advantageous to offer a user a method for licensing and/or access authorization of software modules for industrial control and/or computer systems.

### SUMMARY OF THE INVENTION

According to one aspect of the present invention, a method for licensing and/or access authorization of software modules provides that a user created at least one software module with application software and at least one license information is assigned to the created software module.

In conventional approaches, where a user produces a software component and enters into a license agreement with a customer, the license agreement only makes it clear that the software component is subject to usage restrictions. Conversely, the present invention includes a user-implemented license mechanisms for software modules. The user will also be referred to as OEM. Software modules herein include license information that provides an effective license protection. The term software module is hereinafter used synonymously with software program or software component. The OEM is hence in the position to introduce license mechanisms into a system that includes software, for the particular software or only for certain components of the software. If the user, e.g. the OEM, creates one or more application software components relating, for example, to a specific application of a machine tool or to other applications in the field of industrial controls and/or computer systems, then the manufacturer stores in the software component by way of application software, e.g. an engineering system, additional features for licensing. The application software, e.g. an engineering system, is used for creating software modules. Additional features are, for example, license information and/or other additional information. The license information defines the association between the license which is later purchased by a customer, i.e., an end-user, and the application software component. The additional information can, for example, uniquely identify the originator of the application software component.

After the application software component and a license information associated with the software component are completed, the manufacturer can hence protect the software component against subsequent changes by suitable means provided by the system. In this way, features relating, for example, to the required license and/or the functionality or function of the software component can subsequently neither be viewed nor changed. In addition, information about generated software components and their specific license requirements can be added into a license databank via a description file. When a user intends to use the application software component, he has to obtain licenses for its use. The purchased licenses are registered electronically in the license database when the software is delivered.

For example, the use of an application software component can require a PIN, i.e., a special number generated from a PSN (Product Serial Number) of the automation device and the license information supplied by the license database. This is also referred to as an association between license and a PIN. By associating a license with a PIN, the license is removed from the license database and is therefore no longer available, which prevents multiple use of a license. Access to the license database can be provided, for example, via an Internet application, such as a web page or a Java applet.

The generated PIN is downloaded by the user into the automation device. The downloaded application software allows the system to automatically check the license balance based on the license information defined by the manufacturer of the software component.

The automation device can check the PIN, for example, by the following 2-stage process:

1. Does the serial number of device match the number of the license key? In this way, a PIN that has been tampered with, or a wrong PIN can be detected. If these numbers do not agree, then the software components used in the automation device and/or the computer system are regarded as not being licensed.

2. Checking if the PIN includes a license for a used software component. An error is indicated if, for example, a license has been purchased without generating a new PIN.

Only after the two tests have been successfully completed, a software component is considered to be properly licensed. Otherwise, if at least one error is indicated, a software component is considered not licensed so that its use can be prohibited.

The balance of the licenses used in an industrial control or computer system, also referred to as “Debit” and “Credit”, can be openly displayed. In this way, sublicenses can be detected, for example, also via remote diagnosis. The automation device then unmistakably informs the user that the terms of the license agreement have been violated. The license balance can be established, for example, by a license manager.

The invention advantageously allows the method of the invention to be carried out at least partially by an engineering system for automation devices. An engineering system can be implemented to offer the function of providing each software component that is generated with the engineering system with a license. This creates a form of electronic license, since a software component is now provided with license information. An engineering system, a run-time software (RT) and a license database provide system functionality required for licensing of software components. In this way, each originator of a software component, e.g. an OEM, can generate for computer-based office applications (e.g., an equation editor, spell checker, etc.) its own electronic license for the software components, which is automatically checked by the automation device or the computer system without requiring changes in the system software. Such licensing method gives protection to each software component manufacturer for, for example, the development costs of software components.

An exemplary embodiment, also referred to as Use Case, will now be schematically described:

An originator/manufacturer:

Creates at least one of application software component

Enters license information into the application software component(s)

Protects the license information (protection is system-internal in the application software)

Enters the license information into the license database (can also be done automatically)

Sells licenses and registers the licenses in the license database (this can also be done automatically)

A user:

purchases licenses

associates licenses with a PIN via the PSN with the help of the license database

receives PIN

loads PIN into the automation device

loads application software component into the automation device

A system:

An automation device automatically checks the license balance across all application software components, and

displays errors in sublicenses and/or prevents use of the application software component

According to the invention, the following situations can arise:

Licensing of software components and/or software libraries is done by the originator

Licensing of application-specific firmware components (technological objects) is done by the originator

A license database registers the licenses and can also generate PIN's , for example via a web page

System support for licensing of application software components (libraries, application-specific firmware components)

Recalling the license balance (nominal-actual) in the automation device via diagnostic checking services

Access to a license database via a web page.

For example, licenses are specific licenses for applications. Exemplary licenses for machine tools are licenses for software modules, such as software for multi-axis processing, concentricity/run-out or radial cam disks. However, licenses can also be supplied in an abstract form as value points. In a method for licensing and/or access authorization of software modules, i.e., software components, a customer can obtain value points for authorizing desired software modules. Each software module has a valuation in the form of value points. A customer or the user is authorized to use the software modules if the number of value points acquired by the customer is at least equal to the sum of value points necessary for the actually desired software modules. The license manager can then permanently or sporadically compute and monitor the actual balance between the acquired and used value points.

A license manager can also be employed with those licenses where a particular license is associated with each type of software module (e.g., synchronization, radial cam disk, etc.). The license manager can also be implemented as a mobile agent.

Advantageously, the software can be licensed and/or access can be authorized for software modules subject to a license by comparing the number of required licenses with the number of obtained licenses when the software modules are actually used. In this way, application-specific licenses can be provided to a customer for his specific requirements. The licenses can hence be coupled to the number of manifestations and/or instantiations of the software modules. A customer who acquires a software module, for example a technology packet “positioning”, for motion control in an industrial controller, does not pay for the software when he installs the technology packet, but rather only pays when a technology object of this technology packet “positioning” is actually used. The technology packet “positioning” can also include the technology object “positioning axis.” A customer is billed for the required number of manifestations and/or instances of the technology object “positioning axis” or additional technology objects, i.e., his license account is debited for the number of the manifestations and/or instances of the technology objects. By authorizing specific instances at run-time, the license account of a customer is only debited for those software modules which are actually needed and used for the applications. This provides for a finely granulated accounting mechanism, so that a customer has to pay only for the required and actually used functionality. Different technology objects and/or software modules are used, for example, in machine tools with CNC control. A license account indicates the number and type licenses for a customer; this process can be installed and administered electronically and automatically by a license manager.

Licenses can be stored on memory cards and/or MMC memory cards by providing these computer-readable data carriers with an unchangeable hardware identification and with additional license information in form of an identification number that is generated by a encryption algorithm and uniquely associates the hardware identification with the license information, which are then supplied to a computer system or the control device that execute the software components in form of the computer-readable data carrier.

Advantageously, the unique hardware identification (ID) which is placed on the data carrier by the manufacturer during the manufacturing process of the computer-readable data carrier, is written in a region of the data carrier which is subsequently only readable, but not writable. The hardware ID is only given out once and is therefore unique. Since a region containing the hardware ID can only be read out, but not written to, the hardware ID (for example the serial number) cannot be copied to another data carrier of this type, which makes cloning of data carriers impossible. In addition to the hardware ID, the computer-readable data carrier includes additional useful data regions which may be writable.

The usable data regions of the computer readable data carrier can include, for example, information which can be used for operating a computer system or a control device. To operate controllers, the usable data regions of the computer-readable data carrier can include, for example, the complete run-time software and/or parameterization and/or configuration information, as well as applications.

### BRIEF DESCRIPTION OF THE DRAWING

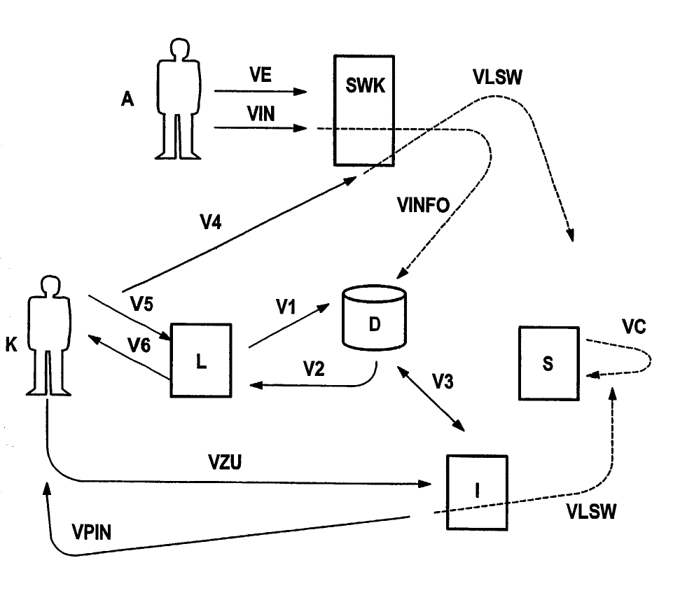

Other features and advantages of the present invention will be more readily apparent upon reading the following description of a currently preferred exemplified embodiment of the invention with reference to the accompanying drawing, in which the sole FIG. 1 shows schematically the generation and licensing of an application software component.

### DETAILED DESCRIPTION OF PREFERRED EMBODIMENTS

Turning now to FIG. 1, there is shown an example for licensing of software components SWK supplied by a user A to a customer K. The user A creates an application software component SWK. This process is indicated by an arrow VE. The user A also enters into the application software component SWK license information, as indicated by the arrow VIN. The software information VIN is at least partially transmitted to a license database D via a link VINFO. A customer K can now use an application software component SWK, as indicated by the arrow V4. The application software components SWK is transmitted to a controller S and/or a computer system, as indicated by the arrow VLSW. Within the controller S, a license manager can, for example, check and monitor the licenses (as indicated by arrow VL), wherein each software component SWK is supposed to have a corresponding license L. The licenses L can be provided to the controller S in a number of ways. For example, the license can be provided to the controller S via a means I containing information about the license L. The means I can be, for example, an Internet application, such as a web page. The means I is connected for data transmission with the license database D, as indicated by the arrow V3. A customer can now purchase and/or request a license L, as indicated by the arrow V5. The arrow V5 continues via the link V1 to the license database D, from where the license L reaches the customer K via the link V1 indicated by the arrow V2. The customer can receive, depending on the licensing mechanism, one or several PIN numbers which allow licensing of an application software components SWK on a controller S. The arrow VZU, which connects the customer K with the means I, indicates the association of the licenses with a PIN having a PSN which represents a unique hardware identification. The customer K received the PIN number, for example, by purchasing the license L, whereby the license database D transmits the PIN to the means I via the connection V3, with the PIN then being supplied to the customer K via the connection VPIN. If the controller S is connected with the means I for data transmission, then the license L can be provided in the form of data information, such as a PIN number, to the controller S via a communication means and the connection VLSW.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for licensing and/or access authorization of software modules for an industrial control or computer system, comprising the steps of:
creating at least one software module with application software by a user; and
assigning at least one license information to the created software module.

2. The method of claim 1, wherein the license information is protected from unauthorized access.

3. The method of claim 1, wherein the license information is entered into a license database.

4. The method of claim 3, wherein the user transfers a license to a customer and the transfer of the license is registered in the license database.

5. The method of claim 1, wherein a licenses to the at least one software module is administered by a license manager.

6. The method of claim 1, wherein the application software comprises engineering software.

7. Device for carrying out the method of claim 1, wherein an engineering system and a database are connected for data transfer via a communication device, with the database including license information.

8. The device of claim 8, wherein the database is connected for data transfer with the Internet.
